(19) United States
(12) Patent Application Publication
(10) Pub. No.: US 2025/0215128 A1
(43) Pub. Date: Jul. 3, 2025

(54) CURABLE COMPOSITIONS WITH ADHESION PROMOTION AGENTS

(71) Applicant: 3M INNOVATIVE PROPERTIES COMPANY, St. Paul, MN (US)

(72) Inventors: Claire Hartmann-Thompson, Lake Elmo, MN (US); Amanda K. Leone, St. Paul, MN (US); Evan L. Schwartz, Vadnais Heights, MN (US); Anthony J. Ostlund, Forest Lake, MN (US)

(21) Appl. No.: 18/848,731

(22) PCT Filed: Mar. 7, 2023
(86) PCT No.: PCT/IB2023/052170

§ 371 Date: Sep. 19, 2024

Related U.S. Application Data
(60) Provisional application No. 63/326,355, filed on Apr. 1, 2022.

(51) Int. Cl. C08F 220/18; C08F 230/02; C09D 4/00

(52) U.S. Cl. CPC C08F 220/1806; C08F 230/02; C09D 4/00

(57) ABSTRACT

Curable compositions include a curable (meth)acrylate-based component and a co-polymerizable adhesion promoter component. The curable (meth)acrylate-based component has an aromatic (meth)acrylate monomer and/or a branched alkyl (meth)acrylate monomer with 12 or more carbon atoms, a crosslinking monomer, and an initiator. The co-polymerizable adhesion promoter component has a co-polymerizable cyclic imide compound and a co-polymerizable acid-functional compound, or a co-polymerizable isocyanate compound and a co-polymerizable acid-functional compound. The curable composition is solvent free and inkjet printable. Upon curing the curable composition forms an optically clear layer that has increased adhesion to substrates such as silicon oxide, silicon nitride, or silicon oxynitride.

### SUMMARY

Disclosed herein are curable compositions that contain adhesion promotion agents and articles that are prepared using these curable compositions. In some embodiments, the curable composition comprises a curable (meth)acrylate-based component and a co-polymerizable adhesion promoter component. The curable (meth)acrylate-based component comprises at least a first monomer comprising at least one of an aromatic (meth)acrylate monomer or a branched alkyl (meth)acrylate monomer with 12 or more carbon atoms, at least one crosslinking monomer, and at least one initiator. The co-polymerizable adhesion promoter component comprises a co-polymerizable cyclic imide compound and a co-polymerizable acid-functional compound, or a co-polymerizable isocyanate compound and a co-polymerizable acid-functional compound. The curable composition is solvent free and inkjet printable, having a viscosity of less than 30 centipoise at a temperature of from room temperature to less than 60° C., and upon curing forms an optically clear layer. The cured layer has increased adhesion to substrates comprising a silicon oxide, silicon nitride, or silicon oxynitride surface compared to the adhesion of a cured compositions without the adhesion promoter component.

Also disclosed are articles. In some embodiments, the article comprises a substrate comprising a silicon oxide, silicon nitride, or silicon oxynitride surface, a cured organic layer adjacent to at least a portion of the silicon oxide, silicon nitride, or silicon oxynitride surface of the substrate, and an inorganic barrier layer in contact with the cured organic layer. The cured organic layer comprises a crosslinked (meth)acrylate-based layer, and has a thickness of from 1-50 micrometers and is optically clear. The cured organic layer is prepared by curing the curable composition described above

### BRIEF DESCRIPTION OF THE DRAWINGS

The present application may be more completely understood in consideration of the following detailed description of various embodiments of the disclosure in connection with the accompanying drawings.

FIG. 1 is a cross-sectional view of an article of this disclosure.

FIG. 2 is a cross-sectional view of an electronic device of this disclosure.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The increased complexity of optical devices places increasingly difficult-to-meet requirements upon the materials used in them. In particular, organic polymeric materials have found widespread use in optical devices, but increasingly stringent requirements are being placed upon these polymeric materials.

For example, thin organic polymeric films are desirable for a wide range of uses in optical devices, as adhesives, protective layers, spacer layers, and the like. As articles have become more complex, the physical demands upon these layers have increased. For example, as optical devices have become more compact and at the same time often include more layers, there has been an increasing need for thinner layers. At the same time, because the layers are thinner, the layers also need to be more precise. For example, a thin spacer layer (of 1 micrometer thickness) in order to be effective as a spacer needs to be level and free of gaps and holes in order to provide the proper spacing function. This requires deposition of the organic layer in a precise and consistent manner.

One function that thin spacer layers may fulfill in multilayer optical and electronic devices is electrical insulation, in order to electrically isolate a layer or series of layers from other nearby layers. Additionally, not only do these layers have to supply their physical role (adhesion, protection, spacing, and the like) they must also provide the requisite optical properties. Among the properties that are becoming increasingly important are optical clarity and controlled refractive index.

For example, thin film encapsulation (TFE) layers are used to prevent air and moisture ingress into electroluminescent devices such as OLED (organic light-emitting diode) devices and QD (quantum dot) devices. The TFE is typically composed of alternating layers of inorganic and organic materials (Chwang, Applied Physics Letters 83, 413 (2003)). The function of the inorganic layers is to block the ingress of air and moisture into the electroluminescent device. The organic layer can be thought of as a buffer layer that is critical for the success of the inorganic layer barrier function. The functions of the organic layers are twofold: 1) to planarize the substrate and present a smooth interface for the deposition of the inorganic layer; and 2) to decouple any defects (pinholes, micro-cracks) that may occur in the inorganic layers on either side of the organic layer.

Among the methods that have been developed to provide a precise and consistent deposition of organic polymeric material are printing techniques. In printing techniques, a polymer or a curable composition that upon curing forms a polymer, are printed onto a substrate surface to form a layer. In the case of printable polymers, typically solvents are added to make the polymer a solution or dispersion capable of being printed. When polymers are used, typically a drying step is necessary after printing to produce the desired polymeric layer. In the case of curable compositions that upon curing form polymers, the curable compositions may or may not include a solvent. The curable composition is then cured, typically either with the application of heat or radiation (such as UV light) and if a solvent is used the layer may also be dried. A variety of printing techniques can be used, with inkjet printing being particularly desirable because of the excellent precision of inkjet printing.

Among the issues with printable TFE layers is that the substrates on which the layers are printed are often substrates that are difficult for layers to adhere to. Among these substrates are silicon oxide, silicon nitride, and silicon oxynitride. Often the printed layers at least partially lift off from the substrate surface. The likelihood of the layer lifting off the substrate surface can be determined by a range of testing protocols. A particularly suitable testing protocol is the crosshatch adhesion test (ASTM D3359-09) as described in the Examples section. The current curable compositions have increased adhesion to the above-described substrates. In many cases the substrate surface is silicon nitride. Adhesion to silicon nitride substrates is challenging because surface functional groups are sparse. Silicon nitride is made via Plasma Enhanced Chemical Vapor Deposition (PECVD) methods that use reactive gas streams (such as ammonia and SiH₄), and a few residual SiOH groups (resulting from oxidation of SiH) and NH groups are present. The use of (meth)acrylate alkoxysilanes as adhesion promoters for UV-curable acrylates is well known in the art, where the Si(OR) groups interact with inorganic substrate surface SiOH groups (e.g., glass, aluminosilicate) and the (meth)acrylate group reacts into the UV-cured formulation applied to the substrate. However, OLED TFE applications have stringent optical, outgassing and rapid aging specifications, and mobile small molecules (e.g., water or alcohol by-products of SiOR reaction), even at ultra-low levels, can result in the formation of micro-scale defects in aging tests (e.g., 80° C./80% RH/1000 hrs).

Therefore, the need remains for adhesion promoters with functional groups that can react with SiOH and NH groups on the surface of silicon nitride without generating by-products. In this disclosure, curable compositions are described that comprise a curable (meth)acrylate-based component and a co-curable adhesion promoter component that have improved adhesion of the cured (meth)acrylate layer to surfaces such as silicon nitride. The adhesion promoter component comprises a combination of either a cyclic imide and a protic acid or an isocyanate with a protic acid, where the cyclic imide, isocyanate, and protic acid materials are co-polymerizable, that is to say they contain free radically polymerizable groups. Also disclosed herein are articles, especially optical articles, that comprise multiple layers of films, substrates, and coatings. Among the articles of this disclosure are articles comprising a substrate and a cured organic layer adjacent to the substrate. In some embodiments, the articles are electronic devices such as organic light emitting diodes, quantum dot light emitting diodes, micro light emitting diodes, or quantum nanorod electronic devices.

As used herein, the term “adjacent” refers to two layers that are proximate to each other. Layers that are adjacent may be in direct contact with each other, or there may be an intervening layer. There is no empty space between layers that are adjacent.

The curable compositions are “substantially solvent free” or “solvent free”. As used herein, “substantially solvent free” refers to the curable ink compositions having less than 5 wt-%, 4 wt-%, 3 wt-%, 2 wt-%, 1 wt-% and 0.5 wt-% of non-polymerizable (e.g., organic) solvent. The concentration of solvent can be determined by known methods, such as gas chromatography (as described in ASTM D5403). The term “solvent free” refers to there being no solvent present in the composition. It should be noted that whether the curable ink composition is substantially solvent free or solvent free, no solvent is deliberately added.

Typically, the curable compositions are described as “100% solids”. As used herein, “100% solids” refers to curable compositions that do not contain volatile solvents, where all of the mass that is deposited on a surface remains there, and no volatile mass is lost from the coating.

The terms “room temperature” and “ambient temperature” are used interchangeably and have their conventional meaning, referring to temperatures of from 20-25° C.

The term “organic” as used herein to refer to a cured layer, means that the layer is prepared from organic materials and is free of inorganic materials.

The term “(meth)acrylate” refers to monomeric acrylic or methacrylic esters of alcohols. Acrylate and methacrylate monomers or oligomers are referred to collectively herein as “(meth)acrylates”. The term “(meth)acrylate-based” as used herein refers to a polymeric composition that comprises at least one (meth)acrylate monomer and may contain additional (meth)acrylate or non-(meth)acrylate co-polymerizable ethylenically unsaturated monomers. Polymers that are (meth)acrylate based comprise a majority (that is to say greater than 50% by weight) of (meth)acrylate monomers.

The terms “free radically polymerizable” and “ethylenically unsaturated” are used interchangeably and refer to a reactive group which contains a carbon-carbon double bond which is able to be polymerized via a free radical polymerization mechanism.

The terms “polymer” and “oligomer” are used herein consistent with their common usage in chemistry. In chemistry, an oligomer is a molecular complex that consists of a few monomer units, in contrast to a polymer, where the number of monomers repeat units is, in theory, not limited. Dimers, trimers, and tetramers are, for instance, oligomers composed of two, three and four monomer repeat units, respectively. Polymers on the other hand are macromolecules composed of many monomer repeated units.

The term “hydrocarbon group” as used herein refers to any monovalent group that contains primarily or exclusively carbon and hydrogen atoms. Alkyl and aryl groups are examples of hydrocarbon groups.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The term “heteroalkylene” refers to a divalent group that includes at least two alkylene groups connected by a thio, oxy, or —NR— where R is H or an alkyl. The heteroalkylene can be linear, branched, cyclic, substituted with alkyl groups, or combinations thereof. Some heteroalkylenes are poloxyyalkylenes where the heteroatom is oxygen such as for example,

—CH₂CH₂(OCH₂CH₂)ₙOCH₂CH₂—.

The term “heteroarylene” refers to a divalent group that includes at least two arylene groups connected by a thio, oxy, or —NR— where R is H or an alkyl.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 90% and a haze of less than 10%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or even 0.5% at a thickness of 50 micrometers. Typically, optically clear articles have a visible light transmittance of at least 95%, often higher such as 97%, 98% or even 99% or higher.

Disclosed herein are curable compositions that are printable. The curable compositions need not be printed and then cured, the curable compositions can be delivered to substrate surfaces in various ways, but they are capable of being printed. In particular, the printable compositions of this disclosure are typically capable of being inkjet printed, which means that they have the proper viscosity and other attributes to be inkjet printed. The term “inkjet printable” is not a process description or limitation, but rather is a material description, meaning that the curable compositions are capable of being inkjet printed, and not that the compositions necessarily have been inkjet printed. This is akin to the expression hot melt processable, which means that a composition is capable of being hot melt processed but does not mean that the composition has been hot melt processed.

The curable compositions of this disclosure are reactive mixtures that comprise a blend of a curable (meth)acrylate-based component and a co-polymerizable adhesion promoter component. The curable (meth)acrylate-based component comprises at least a first monomer comprising at least one of an aromatic (meth)acrylate monomer or a branched alkyl (meth)acrylate monomer with 12 or more carbon atoms, at least one crosslinking monomer, and at least one initiator. The co-polymerizable adhesion promoter component comprises a co-polymerizable cyclic imide compound and a co-polymerizable acid-functional compound, or a co-polymerizable isocyanate compound and a co-polymerizable acid-functional compound. The curable composition is solvent free and inkjet printable, having a viscosity of less than 30 centipoise at a temperature of from room temperature to less than 60° C. Upon curing, the curable composition forms an optically clear layer where the cured layer has increased adhesion to substrates comprising a silicon oxide, silicon nitride, or silicon oxynitride surface compared to the adhesion of a cured compositions without the co-polymerizable adhesion promoter component. The curable compositions are inkjet printable and are free from solvents. By free from solvents it is meant that no solvents are added to the curable composition, and that no solvents are detectable in the curable composition. The term “solvents” is used herein consistent with the generally understood term of art and encompasses volatile organic and non-organic materials that are liquids at room temperature.

The curable composition comprises a curable (meth)acrylate-based component comprising at least one of an aromatic (meth)acrylate monomer or a branched alkyl (meth)acrylate monomer with 12 or more carbon atoms, at least one crosslinking monomer, and at least one initiator.

A wide range of monomers are suitable for the curable (meth)acrylate-based component. In some embodiments the curable (meth)acrylate-based component comprises one or more aromatic (meth)acrylate monomers, one or more branched alkyl (meth)acrylate monomer with 12 or more carbon atoms, or a combination thereof.

In some embodiments, the curable (meth)acrylate-based component comprises one or more aromatic (meth)acrylate monomers, typically monofunctional aromatic (meth)acrylate monomers. A wide variety of monofunctional (meth)acrylate monomers are suitable. Examples of suitable monofunctional (meth)acrylate monomers are described in PCT publication No. WO 2018/122748.

In other embodiments, the curable (meth)acrylate-based component comprises one or more branched alkyl (meth)acrylate monomer with 12 or more carbon atoms. The term “branched” as used herein is used according to the common understanding of the term when used to describe hydrocarbon chains, and means there is at least one branch point on the chain where a carbon atom of the chain is bonded to at least three other carbon atoms, instead of two carbon atoms as in a linear hydrocarbon.

Monomers with hydrocarbon chains that contain greater than 12 carbon atoms are frequently referred to as “long chain hydrocarbons”. Typically, these long chain hydrocarbons have 12-32 carbon atoms. The long chain hydrocarbons of the present disclosure are branched long chain hydrocarbons, meaning that they have at least one branch point along the hydrocarbon chain. In some embodiments the branched long chain hydrocarbons have more than one branch point and are sometimes referred to as “highly branched hydrocarbons”.

In some embodiments, the branched alkyl (meth)acrylate monomer with 12 or more carbon atoms is derived from a 2-alkyl alkanol: i.e., a Guerbet alkanol. The molar carbon number average of said 2-alkyl alkanols of the Guerbet (meth)acrylates is 12 to 32 (C₁₂-C₃₂), more typically 12 to 20 (C₁₂-C₂₀). Examples of suitable (meth)acrylate monomers are described in PCT Publication No. WO 2019/123123.

In some embodiments, the curable (meth)acrylate-based component comprises both an aromatic (meth)acrylate monomer and a branched alkyl (meth)acrylate monomer with 12 or more carbon atoms. Whether a single monomer is used or a combination of monomers, the amount of (meth)acrylate monomer employed in the curable (meth)acrylate-based component can vary. Typically, the monomer or combination of monomers is the majority of the curable (meth)acrylate-based component composition. By this it is meant that greater than 50% by weight of the curable (meth)acrylate-based component is the monofunctional (meth)acrylate monomer or the branched alkyl (meth)acrylate monomer with 12 or more carbon atoms. Typically, the curable (meth)acrylate-based component compositions comprise greater than 75% by weight of the monomer or combination of monomers. More typically the curable (meth)acrylate-based component composition comprises 90% by weight or greater of the aromatic (meth)acrylate monomer and/or a branched alkyl (meth)acrylate monomer with 12 or more carbon atoms.

The curable (meth)acrylate-based component compositions include at least one crosslinker. Crosslinkers are well understood in the polymer arts as polyfunctional molecules that link polymer chains together. In the present curable compositions, the crosslinker typically is a multifunctional (meth)acrylate. Examples of useful multifunctional (meth)acrylate include, but are not limited to, di(meth)acrylates, tri(meth)acrylates, and tetra(meth)acrylates, such as 1,6-hexanediol di(meth)acrylate, 1,4-butanediol di(meth)acrylate, propylene glycol di(meth)acrylates, ethylene glycol di(meth)acrylates, hydroxy pivalic acid neopentyl glycol di(meth)acrylate, neopentyl glycol di(meth)acrylate, bisphenol A di(meth)acrylates, tricyclodecane dimethanol di(meth)acrylate, poly(ethylene glycol) di(meth)acrylates, polybutadiene di(meth)acrylate, polyurethane di(meth)acrylates, and glycerin tri(meth)acrylate, trimethylolpropane tri(meth)acrylate, tris(2-hydroxyethyl) isocyanurate triacrylate, pentaerythritol tri- and tetra(meth)acrylate and, ditrimethylolpropane tetra(meth)acrylate, dipentaerythritol penta(meth)acrylate, dipentaerythritol hexa(meth)acrylate, ethoxylated and propoxylated versions and mixtures thereof. A particularly suitable crosslinker is trimethylolpropane triacrylate. The amount and identity of the crosslinker or crosslinkers can vary, but typically the total amount of crosslinkers present is at least 5 weight %. By weight % it is meant the % by weight of the total curable components of the curable (meth)acrylate-based component composition.

The curable (meth)acrylate-based component also comprises at least one initiator. Typically, the initiator is a photoinitiator, meaning that the initiator is activated by light, generally ultraviolet (UV) light, although other light sources could be used with the appropriate choice of initiator, such as visible light initiators, infrared light initiators, and the like. More than one initiator can also be used, where the initiators can activate at different wavelengths of light. Thus, the curable mixture compositions are generally curable by UV or visible light, typically UV light. Therefore, typically, UV photoinitiators are used as the initiator. Photoinitiators are well understood by one of skill in the art of (meth)acrylate polymerization. Examples of suitable free radical photoinitiators include IRGACURE 4265, IRGACURE 184, IRGACURE 651, IRGACURE 1173, IRGACURE 819, IRGACURE TPO, IRGACURE TPO-L, commercially available from BASF, Charlotte, NC. Particularly suitable photoinitiators include those that feature high absorbance above 365 nm wavelength. These include the acylphosphine oxide family of photoinitiators such as IRGACURE TPO, IRGACURE TPO-L, and IRGACURE 819.

Generally, the photoinitiator is used in amounts of 0.01 to 10 parts by weight, more typically 0.1 to 2.0, parts by weight relative to 100 parts by weight of total reactive components of the curable (meth)acrylate-based component composition.

The curable composition also comprises a co-polymerizable adhesion promoter component that is co-curable with the curable (meth)acrylate-based component described above. By co-curable it is meant that the components of the adhesion promoter component are co-polymerizable with curable (meth)acrylate-based component. Since the adhesion promoter component is co-curable with the curable (meth)acrylate-based component, the entire curable composition is photocurable, curable with ultraviolet or visible light radiation.

There are two general classes of adhesion promoter components disclosed herein. The first class of adhesion promoter component comprises a co-polymerizable cyclic imide compound and a co-polymerizable acid-functional compound. The second class of adhesion promoter component comprises a co-polymerizable isocyanate compound and a co-polymerizable acid-functional compound. Both classes are described below.

In some embodiments, the first class of adhesion promoter component comprises a co-polymerizable cyclic imide compound and a co-polymerizable acid-functional compound. A wide variety of co-polymerizable cyclic imides are suitable. Many suitable cyclic imides are described in Attorney Docket No. 84268US002, Ser. No. 63/286,285 filed Dec. 6, 2021.

In some embodiments, the co-polymerizable cyclic imide is of Formula 1, below:

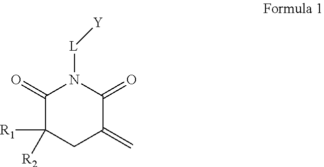

where L is a covalent bond or an organic linking group; Y is alkyl, aryl, hydroxyl, carboxylic acid, or an ethylenically unsaturated polymerizable group; and R₁ and R₂ are independently substituents.

In some embodiments, the co-polymerizable cyclic imide is of Formula 2, below:

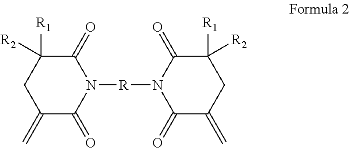

wherein R is a divalent organic linking group; and R₁ and R₂ are independently substituents. R typically comprises (hetero)alkylene, (hetero) arylene, or a combination thereof. In some embodiments, the alkylene or arylene linking group (i.e., R) may comprise heteroatoms, such as oxygen or nitrogen. For example, R may comprise one or more ester moieties, one or more urethane moieties, and/or one or more pendent hydroxyl groups. R may optionally further comprise a pendent ethylenically unsaturated group The groups R₁ and R₂ typically are independently an H or an organic substituent. In some embodiments, R₁ and R₂ are independently C1 to C4 alkyl groups (e.g., methyl, ethyl, propyl, or butyl).

In some embodiments, the co-polymerizable cyclic imide is of Formula 3, below:

H₂C═CR³—(CO)-D-G Formula 3

where R³ is an H atom or a methyl group; (CO) is a carbonyl group C═O; D is a divalent linking group comprising an alkylene or substituted alkylene group with 2-24 carbon atoms; and G is a cyclic imide or substituted cyclic imide group.

In some embodiments, the co-polymerizable acid-functional compound is of Formula 4A or 4B:

H₂C═CR³—(CO)—O—B-A Formula 4A

where R³ is an H atom or a methyl group; (CO) is a carbonyl group C═O; B is divalent linking group comprising an alkylene or substituted alkylene group with 1-8 carbon atoms; A is an acid-functional group —O—P═O(OH)(OR⁴); where R⁴ is an H atom or a —B—O—(CO)—R³C═CH₂ group.

H₂C═CR³—(CO)—B-G-B—(CO)—R³C═CH₂ Formula 4B

where R³ is an H atom or a methyl group; (CO) is a carbonyl group C═O; B is divalent linking group comprising an alkylene or substituted alkylene group with 2 carbon atoms; G is an acid-functional group —CH—O—P═O(OH)₂.

In some specific embodiments, the co-polymerizable adhesion promoter component comprises a co-polymerizable cyclic imide compound and a co-polymerizable acid-functional compound, wherein the co-polymerizable cyclic imide is of Formula 1,

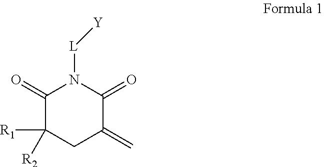

where L comprises an alkylene group, an arylene group, a heteroalkylene group, a heteroarylene group, or a combination thereof; Y is an ethylenically unsaturated polymerizable group; and R₁ and R₂ are organic groups comprising 1-4 carbon atoms; and the co-polymerizable acid-functional compound is of Formula 4A:

H₂C═CR³—(CO)—O—B-A Formula 4A

where R³ is an H atom or a methyl group; (CO) is a carbonyl group C═O; B is a divalent linking group comprising an alkylene or substituted alkylene group with 1-8 carbon atoms; A is an acid-functional group —O—P═O(OH)(OR⁴); and R⁴ is an H atom or a —B—O—(CO)—R³C═CH₂ group; or Formula 4B:

H₂C═CR³—(CO)—B-G-B—(CO)—R³C═CH₂ Formula 4B

where R³ is an H atom or a methyl group; (CO) is a carbonyl group C═O; B is divalent linking group comprising an alkylene or substituted alkylene group with 2 carbon atoms; G is an acid-functional group —CH—O—P═O(OH)₂.

In other specific embodiments, the co-polymerizable adhesion promoter component comprises a co-polymerizable cyclic imide compound and a co-polymerizable acid-functional compound, wherein the co-polymerizable cyclic imide is of Formula 1,

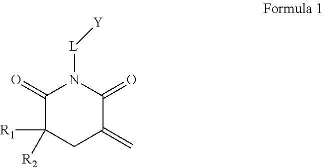

where L comprises heteroalkylene group, and is substituted with one or more pendent hydroxyl groups; Y is a (meth)acrylate group —(CO)—R³C═CH₂, where (CO) is a carbonyl group C═O, and R³ is H or methyl; and R₁ and R₂ are independently organic groups comprising 1-2 carbon atoms; and the co-polymerizable acid-functional compound is of Formula 4A or 4B:

H₂C═CR³—(CO)—O—B-A Formula 4A

where R³ is an H atom or a methyl group; (CO) is a carbonyl group C═O; B is divalent linking group comprising an alkylene or substituted alkylene group with 1-8 carbon atoms; A is an acid-functional group —O—P═O(OH)(OR⁴); wherein R₄ is an H atom or a —B—O—(CO)—R³C═CH₂ group;

H₂C═CR³—(CO)—B-G-B—(CO)—R³C═CH₂ Formula 4B

where R³ is an H atom or a methyl group; (CO) is a carbonyl group C═O; B is divalent linking group comprising an alkylene or substituted alkylene group with 2 carbon atoms; G is an acid-functional group —CH—O—P═O(OH)₂.

In other embodiments, the co-polymerizable adhesion promoter component comprises a co-polymerizable cyclic imide compound and a co-polymerizable acid-functional compound, where the co-polymerizable cyclic imide is of Formula 2,

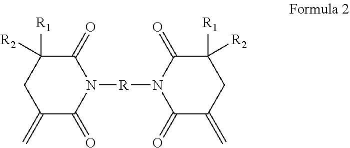

where R is a divalent alkylene, arylene, hetroalkylene, or heteroarylene group; and R₁ and R₂ are independently organic groups comprising 1-2 carbon atoms; and the co-polymerizable acid-functional compound is of Formula 4A:

H₂C═CR³—(CO)—O—B-A Formula 4A

where R³ is an H atom or a methyl group; (CO) is a carbonyl group C═O; B is divalent linking group comprising an alkylene or substituted alkylene group with 1-8 carbon atoms; A is an acid-functional group —O—P═O(OH)(OR⁴); where R₄ is an H atom or a —B—O—(CO)—R³C═CH₂ group;
or Formula 4B:

H₂C═CR³—(CO)—B-G-B—(CO)—R³C═CH₂ Formula 4B

where R³ is an H atom or a methyl group; (CO) is a carbonyl group C═O; B is divalent linking group comprising an alkylene or substituted alkylene group with 2 carbon atoms; G is an acid-functional group —CH—O—P═O(OH)₂.

In other embodiments, the co-polymerizable adhesion promoter component comprises a co-polymerizable cyclic imide compound and a co-polymerizable acid-functional compound, where the co-polymerizable cyclic imide compound is a specific example of the co-polymerizable cyclic imide of Formula 3, namely the compound of Formula 5,

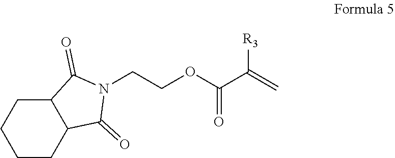

where R³ is an H atom or a methyl group; and the co-polymerizable acid-functional compound is of Formula 4A:

H₂C═CR³—(CO)—O—B-A Formula 4A

where R³ is an H atom or a methyl group; (CO) is a carbonyl group C—O; B is divalent linking group comprising an alkylene or substituted alkylene group with 1-8 carbon atoms; A is an acid-functional group —O—P═O(OH)(OR⁴); where R₄ is an H atom or a —B—O—(CO)—R³C═CH₂ group; or Formula 4B:

H₂C═CR³—(CO)—B-G-B—(CO)—R³C═CH₂ Formula 4B

where R³ is an H atom or a methyl group; (CO) is a carbonyl group C═O; B is divalent linking group comprising an alkylene or substituted alkylene group with 2 carbon atoms; G is an acid-functional group —CH—O—P═O(OH)₂.

Also disclosed are curable compositions that comprise the second class of co-polymerizable adhesion promoter component. The second class of co-polymerizable adhesion promoter component comprises a co-polymerizable isocyanate compound and a co-polymerizable acid-functional compound. In some embodiments, the co-polymerizable adhesion promoter component comprises a co-polymerizable isocyanate compound and a co-polymerizable acid-functional compound, wherein the co-polymerizable isocyanate compound is of Formula 6:

H₂C═CR³—(CO)-E-NCO Formula 6

where R³ is an H atom or a methyl group; E is divalent linking group comprising an alkylene or substituted alkylene group with 2-24 carbon atoms; and the co-polymerizable acid-functional compound is of Formula 4A:

H₂C═CR³—(CO)—O—B-A Formula 4A

where R³ is an H atom or a methyl group; (CO) is a carbonyl group C═O; B is divalent linking group comprising an alkylene, substituted alkylene, heteroalkyene, or aralkylene group with 1-8 carbon atoms; A is an acid-functional group —O—P═O(OH)(OR⁴); where R⁴ is an H atom or a —B—O—(CO)—R³C═CH₂ group; or Formula 4B:

H₂C═CR³—(CO)—B-G-B—(CO)—R³C═CH₂ Formula 4B

where R³ is an H atom or a methyl group; (CO) is a carbonyl group C═O; B is divalent linking group comprising an alkylene or substituted alkylene group with 2 carbon atoms; G is an acid-functional group —CH—O—P═O(OH)₂.

Some specific co-polymerizable acid-functional compounds of Formula 4A and 4B useful in any of the above-described adhesion promoter compositions include the structures:

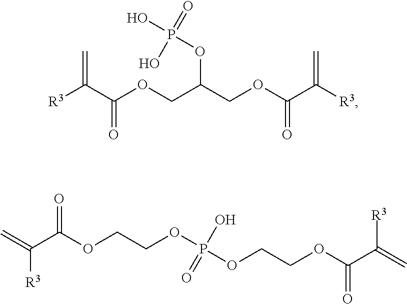

where R³ is a H atom or a methyl group.

Whichever class of co-polymerizable adhesion promoter component is used, the co-polymerizable adhesion promoter component comprises a minor component of the curable composition. Typically, the co-polymerizable adhesion promoter component is present in the amount of 5% or less by weight of the total weight of the curable composition.

In addition to the curable components described above, the curable composition may include additional optional non-curable components, as long as such components do not interfere with curing of the curable composition and do not adversely affect the properties of the cured composition. As mentioned above, solvents are not suitable additives for the curable compositions, as the curable compositions are desirably 100% solids compositions. The curable formulations may also contain polymerization inhibitors, UV absorbers, light stabilizers (e.g., hindered amine light stabilizers (HALS)), synergists, antioxidants, catalysts, dispersants, leveling agents, and the like as needed or desired.

As mentioned above, when the curable compositions are cured, they have a variety of desirable properties. Among the desirable properties are optical clarity, and an increased adhesion to substrates comprising silicon oxide, silicon nitride, or silicon oxynitride compared to the adhesion of cured compositions without the adhesion promoter entity, as demonstrated by improved crosshatch adhesion (as measured by ASTM D3359-09).

Also disclosed herein are articles. A wide variety of articles may be prepared by utilizing the curable compositions described above. When the curable compositions are cured, they form cured organic layers. The articles may be relatively simple articles such as a substrate with a layer of cured organic layer disposed on it. In other embodiments, the articles are more complex, such as multilayer articles comprising a substrate, and an inorganic barrier layer, with a cured organic layer between them, where the cured layer functions as a decoupling layer. The substrate has an inorganic coating layer present on its surface, so that the cured organic layer may be in contact with the inorganic coating layer, where the inorganic coating layer comprises silicon oxide, silicon nitride, or silicon oxynitride.

In some embodiments, articles of this disclosure comprise a substrate comprising a silicon oxide, silicon nitride, or silicon oxynitride surface, a cured organic layer adjacent to at least a portion of the silicon oxide, silicon nitride, or silicon oxynitride surface of the substrate, where the cured organic layer comprises a crosslinked (meth)acrylate-based layer, having a thickness of from 1-50 micrometers, and is optically clear, and an inorganic barrier layer in contact with the cured organic layer. The cured organic layer is formed from a curable composition that has been disposed and cured on the second major surface of the substrate. The curable compositions have been described in detail above and comprise a curable (meth)acrylate-based component and a co-polymerizable adhesion promoter component. The curable (meth)acrylate-based component comprises at least one monomer of an aromatic (meth)acrylate monomer or a branched alkyl (meth)acrylate monomer with 12 or more carbon atoms, at least one crosslinking monomer, and at least one initiator. Each of these components is described above. The co-polymerizable adhesion promoter component comprises a co-polymerizable cyclic imide compound and a co-polymerizable acid-functional compound, or a co-polymerizable isocyanate compound and a co-polymerizable acid-functional compound. Each of these components is described above.

In the articles of this disclosure, the cured organic layer has increased adhesion to the substrate when compared to the same cured organic layer without the adhesion promoter entity, as measured by crosshatch adhesion (ASTM D3359-09).

A wide variety of articles can be prepared using the curable compositions in described above. In some embodiments, the article comprises an electronic device and the substrate comprises an optical electronic component. Examples of suitable optical electronic component comprises at least one of an organic light emitting diode, a quantum dot light emitting diode, a micro light emitting diode, or a quantum nanorod electronic device. An example of a particularly suitable optical electronic component is an organic light emitting diode (OLED).

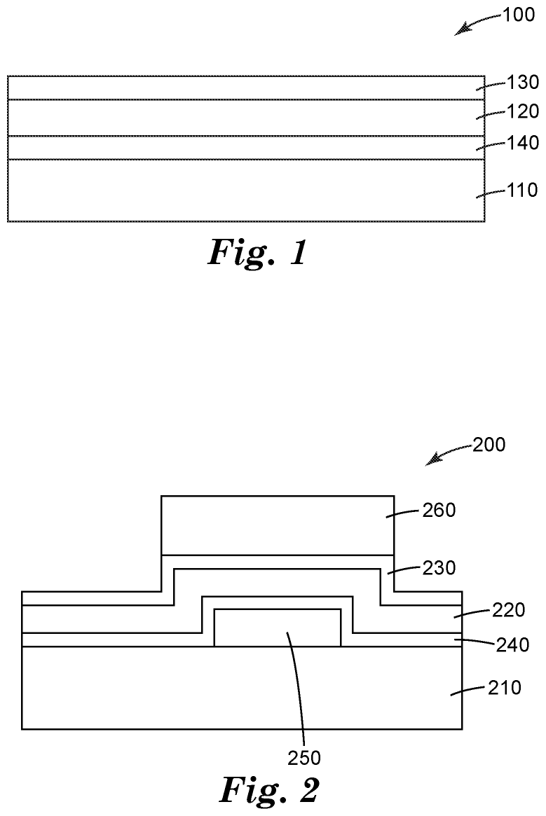

The articles may be further understood by referring to the figures. An exemplary article is shown in FIG. 1, where article 100 comprises substrate 110 with inorganic surface layer 140 (silicon oxide, silicon nitride, or silicon oxynitride), cured organic layer 120 adjacent to the surface layer 140 of the substrate 110, and inorganic barrier layer 130 in contact with cured organic layer 120.

Substrate 110 includes a wide array of flexible and non-flexible substrates. For example, substrate 110 may be glass or a relatively thick layer of a polymeric material such as PMMA (polymethyl methacrylate) or PC (polycarbonate). Alternatively, substrate 110 may be flexible polymeric film such as films of PET (polyethylene terephthalate), PEN (polyethylene naphthalate), PC (polycarbonate), polyimide, PEEK (polyetherether ketone), and the like.

Substrate 110 has a surface inorganic surface layer 140 where the inorganic layer 140 comprises silicon oxide, silicon nitride, or silicon oxynitride. The thickness of the inorganic surface layer 140 is not particularly limited, generally it is between 20 nanometers and 1 micrometer (1000 nanometers). More typically the thickness is from 20 nanometers to 100 nanometers.

Cured organic layer 120 is a (meth)acrylate-based cured layer of the curable ink compositions described above. Again, it is important to note that while the curable composition is described as an “ink”, this just means that the composition is printable and not necessarily that the cured organic layer 120 has been printed, since as described above, other coating methods can also be used. In many embodiments, however, the cured organic layer 120 has been coated by printing, especially inkjet printing, and then has been cured. Cured organic layer 120 has all of the properties described above, namely the layer has a thickness of from 1-50 micrometers and is optically clear.

The inorganic layer barrier layer 130 in contact with cured organic layer 120 can be prepared from a variety of materials including metals, metal oxides, metal nitrides, metal oxynitrides, metal carbides, metal oxyborides, and combinations thereof. Various metals are suitable for use in the metal oxides, metal nitrides, and metal oxynitrides, particularly suitable metals include Al, Zr, Si, Zn, Sn, and Ti. In some embodiments, the inorganic barrier layer 130 has the same composition as inorganic surface layer 140 described above.

While the refractive index of the inorganic barrier layer 130 is not particularly limited, generally it is greater than 1.60, and in many embodiments the refractive index of the inorganic barrier layer is 1.70 or greater. One particularly suitable inorganic barrier layer material is silicon nitride.

The thickness of the inorganic barrier layer 130 is not particularly limited, generally it is between 20 nanometers and 1 micrometer (1000 nanometers). More typically the thickness is from 20 nanometers to 100 nanometers.

The inorganic barrier layer can be deposited on the cured organic layer 120 in a variety of ways. In general, any suitable deposition method can be utilized. Examples of suitable methods include vacuum processes such as sputtering, chemical vapor deposition, metal-organic chemical vapor deposition, plasma enhanced chemical vapor deposition, evaporation, sublimation, electron cyclotron resonance-plasma enhanced chemical vapor deposition, and combinations thereof.

FIG. 2 shows a device that includes a multilayer article of the present disclosure. FIG. 2 shows device 200 comprising substrate 210 with surface inorganic layer 240, device 250 disposed on surface layer 240 of substrate 210. As with FIG. 1 above, cured organic layer 220 is adjacent to the surface layer 240 of substrate 210 and device 250, and inorganic barrier layer 230 in contact with cured organic layer 220. Optional layer 260 may be a single layer or multiple layers and may include both organic and inorganic layers and may include adhesive layers, optical layers, and the like. Layers 210 (substrate), 240 (inorganic surface layer), 220 (cured organic layer), and 230 (inorganic barrier layer) are the same as described above for FIG. 1.

Device 250 may comprise a variety of devices, especially optical devices for which the use of an inorganic barrier layer is useful. Among the particularly suitable devices are electroluminescent devices such as OLED devices or QD devices. Electroluminescent devices have been described above.

### EXAMPLES

These examples are merely for illustrative purposes only and are not meant to be limiting on the scope of the appended claims. The following abbreviations are used: cm=centimeters; nm=nanometers; mW=milliWatts; PBW=Parts By Weight. The terms “weight %”, “% by weight”, and “wt %” are used interchangeably.

Table of Abbreviations

| Abbreviation | Trade Name | Chemical Name | Supplier |
|---|---|---|---|
| Imide 1 | M1088 | 2-(1,2- | Miwon (Exton |
| | | Cyclohexadienyldicarboximide)ethyl | PA) |
| | | acrylate | |
| Imide 2 | M1089 | 2-(1,2- | Miwon |
| | | Cyclohexadienyldicarboximide)ethyl | |
| | | methacrylate | |
| Imide 3 | — | CIM2 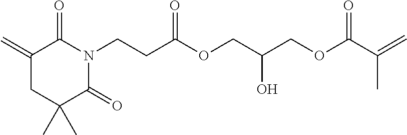 [SMILES: C=C(C)C(=O)OCC(O)COC(=O)CCN1C(=O)C(=C)CC(C)(C)C1=O] | Prepared as described in Attorney Docket No. 84268US002, Serial No. 63/286285 filed 12/6/2021 |
| Imide 4 | — | BCIM1 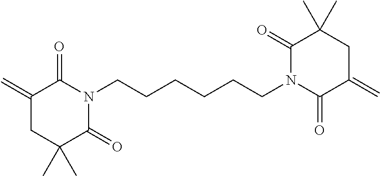 | Prepared as described in Attorney Docket No. 84268US002, Serial No. 63/286285 filed 12/6/2021 |
| IEMA | I1111 | Isocyanatoethylmethacrylate | TCI (Portland, |
| | | | OR) |
| BMEP | 496758 | Bis(2-methacryloxyethyl phosphate) | Millipore Sigma |
| | | | (St. Louis, MO) |
| MI | Purified | Biphenyl methyl acrylate | Miwon |
| | M1192HP | | |
| M2 | M3130 | Trimethylolpropane(EO)3 triacrylate | Miwon |
| M3 | BYK-361 | Polyacrylate | BYK |
| | | | (Wallingford, |
| | | | CT) |
| M4 | OMNIRAD | Diphenyl(2,4,6- | IGM Resins |
| | 819 | trimethylbenzoyl)phosphine oxide | USA, Inc., |
| | | | (Charlotte, NC) |
| M5 | IRGANOX | Pentaerythritol tetrakis[3-[3,5-di- | BASF (Florham |
| | 1010 | tert-butyl-4- | Park, NJ) |
| | | hydroxyphenyl]]propionate | |
| HTEMPO | PROSTAB | 1-Piperidinyloxy, 4-hydroxy-2,2,6,6- | Millipore Sigma |
| | 5198 | tetramethyl | |
| SiNx | Silicon | SILICON WAFER, WITH | WaferPro (Santa |
| | Nitride | 5,000Å = 7% PECVD LOW STRESS | Clara, CA) |
| | | NITRIDE ON POLISHED FRONT | |
| | | SIDE ONLY | |
| | | REFRACTIVE INDEX: 1.98 ± .07 | |
| | | @ 632.8 nm | |
| | | FILM STRESS: ≤250 MPa | |
| | | TENSILE STRESS | |

### Test Methods

### Crosshatch Adhesion

Crosshatch adhesion tests on cured samples were performed as described in ASTM D3359-09 (Standard Test Methods for Measuring Adhesion by Tape Test) where 0B denotes poor adhesion (greater than 65% of area detached upon tape removal) through a range up to 5B which denotes the best adhesion (no detachment and no damage to scored crosshatch lines upon tape removal). The crosshatch testing was conducted using 3M SCOTCH 232 Tape. Two grids/tests were run for a given formulation.

### EXAMPLES

### Preparation of Curable Composition Formulation (CE1)

A base curable composition formulation was prepared (Comparative Example CE1). Mixtures of formulation components as shown in Table 1 were sonicated until a homogenous solution was formed.

TABLE 2
Composition of base high refractive index ink formulation.

| | M1 | M2 | M3 | M4 | M5 | HTEMPO |
|---|---|---|---|---|---|---|
| | (PBW) | (PBW) | (PBW) | (PBW) | (PBW) | (PBW) |
| CE1 | 63 | 37 | 0.1 | 2 | 0.08 | 0.04 |

### Preparation of Cured Coating (CE1)

The base curable composition was coated onto SiNx wafers (WaferPro, Santa Clara, CA) that were dehydrated for 15 minutes on a 250° C. hotplate, followed by a 5 minute UV/ozone treatment (Novascan PSDP-UVT UV Ozone cleaners, Boone, IA). The cleaned wafers were used within 1 hr.

Preparation of Curable Composition Formulations with Adhesion Promoter Additives (CE2-CE6 and E1-E9)

To the base curable Composition formulation described above were added the Adhesion Promoter Additives shown in Table 3. The Comparative Examples CE2-CE6 contain just a cyclic imide additive or isocyanato additive, Examples E1-E9 contain a cyclic imide or isocyanato and an acid.

### Preparation of Cured Coatings (CE2-CE6 and E1-E9)

The formulations were hand spread on the cleaned SiNx wafers using a #10 Mayer rod, purged in a chamber filled with a nitrogen atmosphere for 90 seconds, then cured using a 395 nm UV-LED light (Phoseon FJ200) unit at 500 mW/cm² for 30 seconds.

### Crosshatch Adhesion Testing of Cured Coatings

Crosshatch adhesion results for base formulations with various additives are shown in Table 3. No adhesion indicates that the entire area was removed by the tape (vs. 0B where a few percent of grid squares remain).

TABLE 3
Crosshatch Adhesion

| | | | Crosshatch | Crosshatch |
|---|---|---|---|---|
| | | Level | adhesion | adhesion |
| Example | Additive | (wt %) | (Silicon nitride) | (Glass) |
| CE1 | None (control) | 0 | No adhesion | No adhesion |
| CE2 | Imide 1 | 5 | No adhesion | No adhesion |
| CE3 | Imide 2 | 5 | No adhesion | — |
| E1 | 60/40* BMEP/Imide 1 | 2 | 1B | 5B |
| E2 | 30/70 BMEP/Imide 1 | 5 | 1B | — |
| E3A | 10/90 BMEP/Imide 1 | 2 | 1B | 4B |
| E3B | | 1 | 0B | 0B |
| E4A | 5/95 BMEP/Imide 1 | 4 | 0B | 4B |
| E4B | | 2 | 0B | 4B |
| E5A | 2/98 BMEP/Imide 1 | 4 | 2B | 4B |
| E5B | | 3 | 1B | — |
| E5C | | 2 | 0B | 0B |
| E6 | 1/99 BMEP/Imide 1 | 4 | 0B | 0B |
| CE4 | Imide 3 | 2 | No adhesion | No adhesion |
| E7 | 50/50 BMEP/Imide 3 | 4 | 0B | 3B |
| CE5 | Imide 4 | 2 | No adhesion | 0B |
| E8 | 50/50 BMEP/Imide 4 | 4 | 0B | 2B |
| CE6 | IMEA | 5 | No adhesion | — |
| E9A | 67/33* | 5 | 0B | — |
| E9B | BMEP/IMEA | 2 | 2B | — |
| E9C | 30/70 BMEP/IMEA | 5 | 1B | — |

*Denotes 1:1 molar ratio of POH acid group to imide or isocyanato group.

What is claimed is:

1. A curable composition comprising:
a curable (meth)acrylate-based component comprising:
at least a first monomer comprising at least one of an aromatic (meth)acrylate
monomer or a branched alkyl (meth)acrylate monomer with 12 or more carbon atoms;
at least one crosslinking monomer; and
at least one initiator; and
a co-polymerizable adhesion promoter component comprising:
a co-polymerizable cyclic imide compound and a co-polymerizable acid-functional compound, or a co-polymerizable isocyanate compound and a co-polymerizable acid-functional compound;
wherein the curable composition is solvent free and inkjet printable, having a viscosity of less than 30 centipoise at a temperature of from room temperature to less than 60° C., and upon curing forms an optically clear layer wherein the cured layer has increased adhesion to substrates comprising a silicon oxide, silicon nitride, or silicon oxynitride surface compared to the adhesion of a cured compositions without the adhesion promoter component.

2. The curable composition of claim 1, wherein the co-polymerizable adhesion promoter component comprises a co-polymerizable cyclic imide compound and a co-polymerizable acid-functional compound, wherein the co-polymerizable cyclic imide is of Formula 1, Formula 2, or Formula 3: 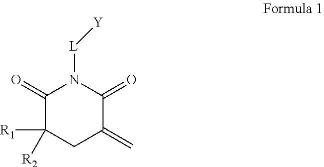
wherein L is a covalent bond or an organic linking group;
Y is alkyl, aryl, hydroxyl, carboxylic acid, or an ethylenically unsaturated polymerizable group; and
R₁ and R₂ are independently substituents; 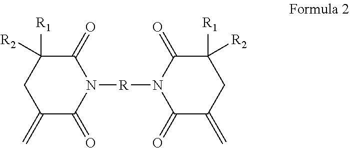
wherein R is a divalent organic linking group; and R₁ and R₂ are independently substituents;
H₂C═CR³—(CO)-D-G Formula 3
wherein R³ is an H atom or a methyl group;
(CO) is a carbonyl group C═O;
D is a divalent linking group comprising an alkylene or substituted alkylene group with 2-24 carbon atoms; and
G is cyclic imide or substituted cyclic imide group;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

3. The curable composition of claim 1, wherein the co-polymerizable adhesion promoter component comprises a co-polymerizable cyclic imide compound and a co-polymerizable acid-functional compound, wherein the co-polymerizable cyclic imide is of Formula 1, 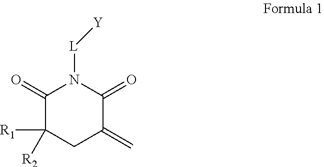
wherein L comprises an alkylene group, an arylene group, a heteroalkylene group, a heteroarylene group, or a combination thereof;
Y is an ethylenically unsaturated polymerizable group; and
R₁ and R₂ are organic groups comprising 1-4 carbon atoms;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

4. The curable composition of claim 1, wherein the co-polymerizable adhesion promoter component comprises a co-polymerizable cyclic imide compound and a co-polymerizable acid-functional compound, wherein the co-polymerizable cyclic imide is of Formula 1, 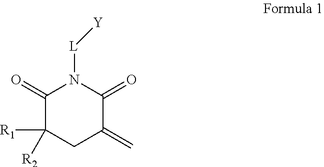
wherein L comprises heteroalkylene group, and is substituted with one or more pendent hydroxyl groups;
Y is a (meth)acrylate group —(CO)—R³C═CH₂, where (CO) is a carbonyl group C═O, and
R³ is H or methyl; and
R₁ and R₂ are independently organic groups comprising 1-2 carbon atoms;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

5. The curable composition of claim 1, wherein the co-polymerizable adhesion promoter component comprises a co-polymerizable cyclic imide compound and a co-polymerizable acid-functional compound, wherein the co-polymerizable cyclic imide is of Formula 2, 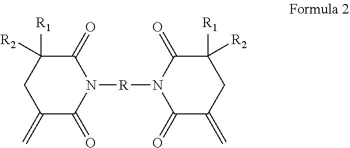
wherein R is a divalent alkylene, arylene, hetroalkylene, or heteroarylene group; and
R₁ and R₂ are independently organic groups comprising 1-2 carbon atoms;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

6. The curable composition of claim 1, wherein the co-polymerizable adhesion promoter component comprises a co-polymerizable cyclic imide compound and a co-polymerizable acid-functional compound, wherein the co-polymerizable cyclic imide is of Formula 5, 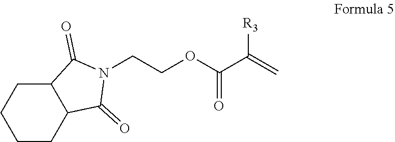
wherein R³ is an H atom or a methyl group;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

7. The curable composition of claim 1, wherein the co-polymerizable adhesion promoter component comprises a co-polymerizable isocyanate compound and a co-polymerizable acid-functional compound, wherein the co-polymerizable isocyanate compound is of Formula 6:
H₂C═CR³—(CO)-E-NCO Formula 6
wherein R³ is an H atom or a methyl group;
E is divalent linking group comprising an alkylene or substituted alkylene group with 2-24 carbon atoms;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene, substituted alkylene, heteroalkyene, or aralkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

8. The curable composition of claim 1, wherein the co-polymerizable acid-functional compound comprises:

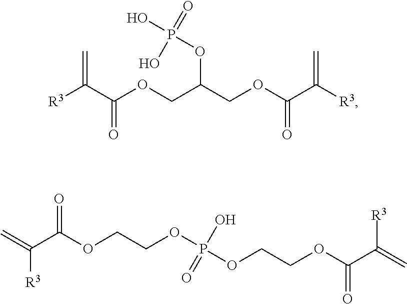

9. The curable composition of claim 1, wherein the increased adhesion to substrates comprising silicon oxide, silicon nitride, or silicon oxynitride compared to the adhesion of cured compositions without the adhesion promoter entity comprises improved crosshatch adhesion (as measured by ASTM D3359-09).

10. The curable composition of claim 1, wherein the curable composition comprises no greater than 5% by weight of the co-polymerizable adhesion promoter component.

11. The curable composition of claim 1, wherein the curable composition is photocurable, curable with ultraviolet or visible light radiation.

12. An article comprising:
a substrate comprising a silicon oxide, silicon nitride, or silicon oxynitride surface;
a cured organic layer adjacent to at least a portion of the silicon oxide, silicon nitride,
or silicon oxynitride surface of the substrate, wherein the cured organic layer
comprises a crosslinked (meth)acrylate-based layer, and has a thickness of from 1-50
micrometers and is optically clear; and
an inorganic barrier layer in contact with the cured organic layer, wherein the cured organic layer is formed from a curable composition that has been disposed and cured on the second major surface of the substrate, wherein the curable composition comprises:
a (meth)acrylate-based component comprising:
at least one of an aromatic (meth)acrylate monomer or a branched alkyl
(meth)acrylate monomer with 12 or more carbon atoms;
at least one crosslinking monomer; and
at least one initiator; and
an co-polymerizable adhesion promoter component wherein the co-polymerizable adhesion promoter component comprises:
a co-polymerizable cyclic imide compound and a co-polymerizable acid-functional compound; or
a co-polymerizable isocyanate compound and a co-polymerizable acid-functional compound.

13. The article of claim 12, wherein the cured organic layer has increased adhesion to the substrate when compared to the same cured organic layer without the adhesion promoter entity, as measured by crosshatch adhesion (ASTM D3359-09).

14. The article of claim 12, wherein the co-polymerizable adhesion promoter component comprises a co-polymerizable cyclic imide compound and a co-polymerizable acid-functional compound, wherein the co-polymerizable cyclic imide is of Formula 1, Formula 2, or Formula 3: 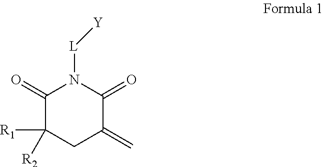
wherein L is a covalent bond or an organic linking group;
Y is alkyl, aryl, hydroxyl, carboxylic acid, or an ethylenically unsaturated polymerizable group; and
R₁ and R₂ are substituents; 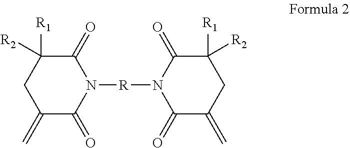
wherein R is a divalent organic linking group; and R₁ and R₂ are independently substituents;
H₂C═CR³—(CO)-D-G Formula 3
wherein R³ is an H atom or a methyl group;
(CO) is a carbonyl group C═O;
D is a divalent linking group comprising an alkylene or substituted alkylene group with 2-8 carbon atoms; and
G is cyclic imide or substituted cyclic imide group;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P⊚O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

15. The article of claim 12, wherein the co-polymerizable adhesion promoter component comprises a co-polymerizable cyclic imide compound and a co-polymerizable acid-functional compound, wherein the co-polymerizable cyclic imide is of Formula 1, 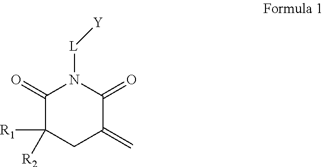
wherein L comprises an alkylene group, an arylene group, a heteroalkylene group, a heteroarylene group, or a combination thereof;
Y is an ethylenically unsaturated polymerizable group; and
R₁ and R₂ are organic groups comprising 1-4 carbon atoms;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

16. The article of claim 12, wherein the co-polymerizable adhesion promoter component comprises a co-polymerizable cyclic imide compound and a co-polymerizable acid-functional compound, wherein the co-polymerizable cyclic imide is of Formula 1, 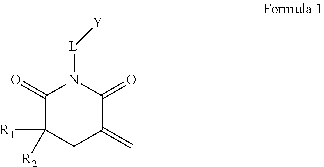
wherein L comprises heteroalkylene group, and is substituted with one or more pendent hydroxyl groups;
Y is a (meth)acrylate group —(CO)—R³C═CH², where (CO) is a carbonyl group C═O, and
R³ is H or methyl; and
R₁ and R₂ are independently organic groups comprising 1-2 carbon atoms;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

17. The article of claim 12, wherein the co-polymerizable adhesion promoter component comprises a co-polymerizable cyclic imide compound and a co-polymerizable acid-functional compound, wherein the co-polymerizable cyclic imide is of Formula 2, 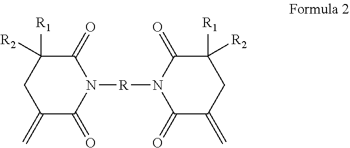
wherein R is a divalent alkylene, arylene, hetroalkylene, or heteroarylene group; and
R₁ and R₂ are independently organic groups comprising 1-2 carbon atoms;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

18. The article of claim 12, wherein the co-polymerizable adhesion promoter component comprises a co-polymerizable isocyanate compound and a co-polymerizable acid-functional compound, wherein the co-polymerizable isocyanate compound is of Formula 6:
H₂C═CR³—(CO)-E-NCO Formula 6
wherein R³ is an H atom or a methyl group;
E is divalent linking group comprising an alkylene or substituted alkylene group with 2-24 carbon atoms;
and the co-polymerizable acid-functional compound is of Formula 4A or 4B:
H₂C═CR³—(CO)—O—B-A Formula 4A
wherein R³ is an H atom or a methyl group;
(CO) is a carbonyl group C═O;
B is divalent linking group comprising an alkylene or substituted alkylene group with 1-8 carbon atoms;
A is an acid-functional group —O—P═O(OH)(OR⁴);
wherein R⁴ is an H atom or a —B—O—(CO)—R³C═CH₂ group;
H₂C═CR³—(CO)—B-G-B—(CO)—R³C═CH₂ Formula 4B
wherein R³ is an H atom or a methyl group;
(CO) is a carbonyl group C═O;
B is divalent linking group comprising an alkylene or substituted alkylene group with 2 carbon atoms;
G is an acid-functional group —CH—O—P═O(OH)₂.

19. The article of claim 12, wherein the article comprises an electronic device and the substrate comprises an optical electronic component.

20. The article of claim 19, wherein the optical electronic component comprises at least one of an organic light emitting diode, a quantum dot light emitting diode, a micro light emitting diode, or a quantum nanorod electronic device.

21. The article of claim 20, wherein the optical electronic component comprises an organic light emitting diode (OLED).
